(19) United States
(12) Patent Application Publication
(10) Pub. No.: US 2016/0060395 A1
(43) Pub. Date: Mar. 3, 2016

(54) METHODS AND SYSTEMS FOR THE RECOVERY OF WATER FROM A POLYAMIDE SYNTHESIS PROCESS

(71) Applicants: Thomas A. MICKA, McKinleyville, CA (US); Charles R. KELMAN, SR., Hixson, TN (US); John P. POINSATTE, Hixson, TN (US); Robert J. WELCH, Salisbury, MD (US); Gary R. WEST, Seaford, DE (US)

(72) Inventors: Thomas A. MICKA, McKinleyville, CA (US); Charles R. KELMAN, SR., Hixson, TN (US); John P. POINSATTE, Hixson, TN (US); Robert J. WELCH, Salisbury, MD (US); Gary R. WEST, Seaford, DE (US)

(73) Assignee: INVISTA NORTH AMERICA S.A R.L., WILMINGTON, DE (US)

(21) Appl. No.: 14/786,667

(22) PCT Filed: Apr. 15, 2014
(86) PCT No.: PCT/US2014/034077

§ 371 Date: Oct. 23, 2015

Related U.S. Application Data
(60) Provisional application No. 61/818,016, filed on May 1, 2013.

(51) Int. Cl. C08G 69/28; B01J 19/00

(52) U.S. Cl. CPC C08G 69/28; B01J 19/00

(57) ABSTRACT

The present disclosure relates to systems and methods for manufacturing a polyamide. The method can include obtaining, from a reservoir, an aqueous solution comprising a dicarboxylic acid, a diamine, and water having a substantially liquid phase; concentrating the aqueous solution including transforming a portion of the water having a substantially liquid phase to water having a substantially gaseous phase; condensing the water having a substantially gaseous phase into condensed water having a substantially liquid phase; removing at least one impurity from at least one of the condensed water having a substantially liquid phase and the water having a substantially gaseous phase to produce cleaned water having a substantially liquid phase; and reusing the cleaned water having a substantially liquid phase. The system can include, among other things, a reservoir; an evaporator assembly, in fluid communication with the reservoir; a condensation assembly, in fluid communication with the evaporator assembly; a collection assembly; and a conduit network.

### CROSS-REFERENCE TO RELATED APPLICATION

This application claims the benefit of priority to U.S. Provisional Patent Application Ser. No. 61/818,016, filed May 1, 2013, the disclosure of which is incorporated herein in its entirety by reference.

### BACKGROUND

Polyamides are obtained via a process where a diamine (e.g., hexamethylene-1,6-diamine) and a dicarboxylic acid (e.g., adipic acid), sometimes in the form of ammonium carboxylate salt of the two components in water, are polymerized under condensation polymerization conditions (e.g., at temperatures ranging from 180° C. to 300° C.). The condensation reaction produces a polyamide (e.g., nylon 6,6) and water, as a byproduct. In some cases, the process can include concentrating the ammonium carboxylate salt solution before the solution is subsequently transferred into a reactor. The process of concentrating the ammonium carboxylate salt solution generates water, which is allowed to escape into the atmosphere as steam or is condensed to form liquid water. The condensed liquid water is then typically discarded into the sewage system (e.g., after waste water treatment) of the polyamide-producing facility.

The disposal of water may be of little to no consequence in jurisdictions where there is no limit with regard to the amount of water that may be disposed into the local sewage system or where it is relatively cheap to dispose of water into the sewage system. But jurisdictions exist where there is a limit with regard to the amount of water that may be discarded and there are significant cost consequences associated with exceeding that limit. Additionally, the use of large volumes of demineralized water can present a significant cost. Accordingly, there is an ongoing need for methods and systems for recovering water from polyamide-producing facilities, especially in jurisdictions that impose significant cost consequences when the water disposal limit is exceeded.

### SUMMARY

The present disclosure addresses the ongoing need for the reduction of the amount of waste water produced during the manufacture of polyamides by reusing a portion of the water that is produced in the polyamide manufacturing process.

### DESCRIPTION OF THE DRAWING

The drawing illustrates generally, by way of example, but not by way of limitation, an embodiment discussed in the present disclosure.

FIG. 1 is a schematic representation of a system for the manufacture of a polyamide.

### DESCRIPTION

The present disclosure addresses the ongoing need for the reduction of the amount of waste water produced during the manufacture of polyamides by reusing a portion of the water that is produced in the polyamide manufacturing process. The present disclosure relates to systems and methods for manufacturing a polyamide comprising: obtaining, from a reservoir, an aqueous solution comprising a dicarboxylic acid, a diamine, and water having a substantially liquid phase; concentrating the aqueous solution including transforming a portion of the water having a substantially liquid phase to water having a substantially gaseous phase; condensing the water having a substantially gaseous phase into water having a substantially liquid phase; removing at least one impurity (e.g., a gelation-causing material or a polyamide-degrading material) from at least one of the condensed water having a substantially liquid phase and the water having a substantially gaseous phase to produce cleaned water having a substantially liquid phase; and reusing the cleaned water having a substantially liquid phase.

As used herein, the term “dicarboxylic acid” refers broadly to C₄-C₁₈ α,ω-dicarboxylic acids. Within this term are subsumed C₄-C₁₀ α,ω-dicarboxylic acids and C₄-C₈ α,ω-dicarboxylic acids. Examples of dicarboxylic acids encompassed by C₄-C₁₈ α,ω-dicarboxylic acids include, but are not limited to, succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), and sebacic acid (decanedioic acid). In some examples, the C₄-C₁₈ α,ω-dicarboxylic acid is adipic acid, pimelic acid or suberic acid. In still other examples, the C₄-C₁₈ α,ω-dicarboxylic acid is adipic acid.

As used herein, the term “diamine” refers broadly to C₄-C₁₈ α,ω-diamines. Within this term are subsumed C₄-C₁₀ α,ω-diamines and C₄-C₈ α,ω-diamines. Examples of diamines encompassed by C₄-C₁₈ α,ω-diamines include, but are not limited to, butane-1,4-diamine, pentane-1,5-diamine, and hexane-1,6-diamine, also known as hexamethylenediamine. In some examples, the C₄-C₁₈ α,ω-diamine is hexamethylenediamine.

In some examples, the use of adipic acid in combination with hexamethyelene diamine is contemplated herein.

As used herein, the term “polyamide” refers broadly to polyamides such as nylon 6, nylon 7, nylon 11, nylon 12, nylon 6,6, nylon 6,9; nylon 6,10, nylon 6,12, or copolymers thereof.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

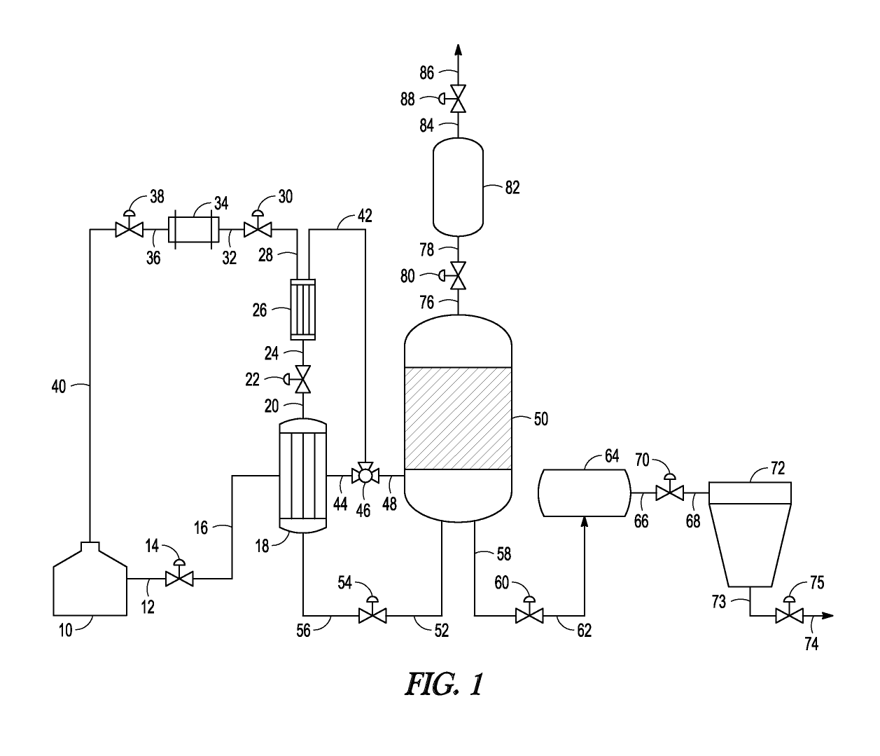

Making reference to FIG. 1, reservoir 10 (sometimes known as a “salt strike”) may contain an aqueous solution comprising a dicarboxylic acid, a diamine, and water having a substantially liquid phase. In some examples, the dicarboxylic acid and the diamine form a salt of the diamine and the dicarboxylic acid, such as an ammonium or diammonium salt, which is dissolved in water in the reservoir 10. The reservoir 10 may be used to mix or store the aqueous solution. The type of reservoir contemplated for reservoir 10 is not limited and can be any suitable reservoir.

In one example, the aqueous solution is routed via line 12, valve 14, and line 16 to an evaporator 18 where the aqueous solution is concentrated by transforming a portion of the water having a substantially liquid phase (e.g., by heating at a temperature from about 100° C. to about 300° C.) to water having a substantially gaseous phase.

At least one of the water having a substantially gaseous phase and the condensed water having a substantially liquid phase can enter a condensation assembly 26. The condensation assembly can be any suitable condensation assembly (or heat exchange unit that can transfer heat to other components of the polyamide manufacturing process by line 20, valve 22, and line 24) that condenses at least some of the water having a substantially gaseous phase into a condensed water having a substantially liquid phase. In some embodiments, the condensation assembly includes a condenser that condenses the water having a substantially gaseous phase to give a condensed water having a substantially liquid phase, as shown in FIG. 1, which can flow to a filtration or absorption assembly. The condenser can be a simple condenser that lacks stages, or can be any one or more unit operations that result in the condensation of a gaseous material to form a liquid material such as a heat exchanger (e.g., a pre-evaporator, a shell and tube heat exchanger, a plate and frame heat exchanger, a reboiler that recovers the latent heat of the water in the gas phase, or an air cooler), a distillation column, a rectification column, or a fractional distillation apparatus. In some examples, a substantial amount of the water having a substantially gaseous phase may be condensed into the condensed water having a substantially liquid phase. When using a distillation column, a rectification column, or a fractional distillation apparatus, the water that emerges in line 28 can include at least one of at least one of water having a substantially gaseous phase, condensed water having a substantially liquid phase, and cleaned water having a substantially liquid phase. The water that emerges in line 28 or line 42 can be substantially demineralized, which can allow for reduced consumption of fresh demineralized water if introduced back into the process, resulting in cost savings.

In some embodiments, the condensation assembly includes at least one of a distillation column, a rectification column, and a fractional distillation apparatus, enabling the condensation assembly to condense the water and at least partially remove at least one gelation-causing material or polyamide-degrading material having a boiling point (BP) that differs from that of water, such as cyclopentanone (BP=131° C.), hexamethyleneimine (BP=138° C.), or bis(hexamethylene)triamine (BP=163-164° C.), giving a cleaned water having a substantially liquid phase, which can flow to a filtration or absorption assembly as shown in FIG. 1, or can without further purifying treatments be used for steam or returned to use via line 40. In some embodiments, the system includes a separate filtration or absorption assembly 34 as shown in FIG. 1. In some embodiments, the condensation assembly includes a filtration or absorption assembly (combined filtration or absorption and condensation assembly not shown in FIG. 1).

In one example, at least some of the condensed water having a substantially liquid phase or the cleaned water having a substantially liquid phase (for embodiments including removal of liquid impurities via distillation or rectification in assembly 26) may be routed by line 28, valve 30, and line 32 to a filter or absorption assembly 34, that removes at least at least one impurity (such as a heavy metal removed via filtration such as titanium, iron, titanium, manganese, magnesium, or cobalt, or an inorganic material such as silica, or an organic material removed via absorption such as cyclopentanone, hexamethyleneimine, or bis(hexamethylene)triamine). A representative filter assembly may be in any suitable configuration and may comprise a coarse filter (e.g., 200 μm) and, optionally, a heat exchanger, both of which may be in line with a first fine filter (e.g., 50 μm). The first fine filter may be in any suitable configuration, including in-line with at least one activated carbon sorbent bed. The water having a substantially liquid phase can then pass through a second fine filter (e.g., 5 μm) to remove any particulate matter that may escape the sorbent bed, including activated carbon sorbent. In some embodiments, assembly 34 can include absorbent materials without other filtration, filtration without absorbent materials, or filtration with absorbent materials.

The water having a substantially liquid phase that emerges by line 36 from the filter or absorption assembly 34 is one example of cleaned water having a substantially liquid phase. In some cases, the water that emerges from the filter or absorption assembly 34, or the water that emerges from a distillation or rectification assembly (e.g., at least one of water having a substantially gaseous phase, condensed water having a substantially liquid phase, and cleaned water having a substantially liquid phase), may be sufficiently pure to be used as a source of steam in the methods and systems described herein for the production of polyamides, e.g., at least about 90 wt % pure, or about 91 wt %, 92, 93, 94, 95, 96, 97, 98, 99, 99.9, 99.99, 99.999, 99.999,9, 99.999,99, or about 99.999,999 wt % or more pure. The cleaned water having a substantially liquid phase may be, e.g., routed by valve 38 and line 40 to reservoir 10.

In various embodiments, the condensation assembly 26 can be a column wherein line 28 or 42 is a side draw, rather than the top stream illustrated in FIG. 1. The side draw can carry the water having a substantially gaseous phase, the water having a substantially liquid phase, cleaned water having a substantially liquid phase, or a combination thereof. Materials having a lower boiling point than water can emerge from the top of the column. In some embodiments, the column can have a bottoms stream exiting the lower portion of the column that can contain materials having a higher boiling point than water (e.g., at least one of adipic acid, hexamethylenediamine, cyclopentanone, hexamethyleneimine, and bis(hexamethylene)triamine). The bottoms stream can carry solid impurities, such as iron, cobalt, titanium, manganese, magnesium, and silica. In some embodiments, the bottoms stream can return reactants to the evaporator 18, optionally first passing through a filter assembly similar to unit 34 to remove solid impurities. In some embodiments, the column can have a side draw below the height that line 28 is drawn from the column (as a top draw or side draw) and above the bottom of the column, such that materials having intermediate boiling points can be removed from the system. For example, in some embodiments, the column can include a bottoms stream that includes materials such as at least one of solid impurities, adipic acid, and hexamethylenediamine, a first side draw that includes at least one of cyclopentanone, hexamethyleneimine, and bis(hexamethylene)triamine, and a top draw or a second side draw above the first side draw that carries at least one of the water having a substantially gaseous phase, the water having a substantially liquid phase, and the cleaned water having a substantially liquid phase.

Heavy metal impurities such as iron, cobalt, manganese, magnesium, and titanium, and organic compounds such as cyclopentanone, hexamethyleneimine, bis(hexamethylene)triamine, and inorganic materials such as silica are examples of gelation-causing material or polyamide degrading material that can participate in chemical reactions that give rise to gel in polyamide reaction mixtures or that can degrade product quality. In some embodiments, heavy metals not soluble in water or minimally soluble in water can flow with the water having a substantially gaseous phase into the recycle apparatus in the form of water droplets containing suspended material therein. Certain heavy metals, such as iron, cobalt, manganese, magnesium, and titanium, and inorganic materials such as silica, can catalyze the formation of gel, including by catalyzing the formation of bis(hexamethylene)triamine. Certain heavy metals, such as iron, cobalt, manganese, magnesium, and titanium, can catalyze the formation of polyamide-degrading materials such as cyclopentanone and hexamethyleneimine. Cyclopentanone, hexamethyleneimine, bis(hexamethylene)triamine can act as end-capping agents (e.g., prematurely terminating polymerization at one or more ends of the polymer), branching agents (e.g., causing polymer strands to loose linearity, which can form gel), and as linear units in the final polyamide product (e.g., which can upset the regular repeating unit of the polyamide, degrading product quality). The water that emerges from the filter or absorption assembly 34 or the cleaned water having a substantially liquid phase that emerges from a distillation or rectification assembly can be suitably free of one or more gelation-causing materials or polyamide-degrading materials such that high water recycle ratios can be achieved without the build-up of gelation-causing materials or polyamide-degrading materials.

The water that emerges from the filter or absorption assembly 34 or the water that emerges from a distillation or rectification assembly in line (e.g., at least one of water having a substantially gaseous phase, condensed water having a substantially liquid phase, and cleaned water having a substantially liquid phase) can have any suitable concentration of heavy metals (e.g., elemental heavy metals or compounds including heavy metals), such as about 1 wt % or less, or about 0.5 wt %, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the evaporator and enters the recycle assembly, the water that emerges from the filter or absorption assembly 34 or the water that emerges from a distillation or rectification assembly can have any suitable reduction in the total amount of heavy metals, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the filter or absorption assembly 34 or the water that emerges from a distillation or rectification assembly (e.g., at least one of water having a substantially gaseous phase, condensed water having a substantially liquid phase, and cleaned water having a substantially liquid phase) can have any suitable concentration of iron (e.g., elemental iron or compounds including iron), such as about 1 wt % or less, or about 0.5 wt %, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the evaporator and enters the recycle assembly, the water that emerges from the filter or absorption assembly 34 or the water that emerges from a distillation or rectification assembly can have any suitable reduction in the amount of the iron, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the filter or absorption assembly 34 or the water that emerges from a distillation or rectification assembly (e.g., at least one of water having a substantially gaseous phase, condensed water having a substantially liquid phase, and cleaned water having a substantially liquid phase) can have any suitable concentration of cobalt (e.g., elemental cobalt or compounds including cobalt), such as about 10 wt % or less, or about 5 wt %, 4.5, 4, 3.5, 3, 2.5, 2, 1.5, 1, 0.5, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the evaporator and enters the recycle assembly, the water that emerges from the filter or absorption assembly 34 or the water that emerges from a distillation or rectification assembly can have any suitable reduction in the amount of the cobalt, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the filter or absorption assembly 34 or the water that emerges from a distillation or rectification assembly (e.g., at least one of water having a substantially gaseous phase, condensed water having a substantially liquid phase, and cleaned water having a substantially liquid phase) can have any suitable concentration of manganese (e.g., elemental manganese or compounds including manganese), such as about 10 wt % or less, or about 5 wt %, 4.5, 4, 3.5, 3, 2.5, 2, 1.5, 1, 0.5, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the evaporator and enters the recycle assembly, the water that emerges from the filter or absorption assembly 34 or the water that emerges from a distillation or rectification assembly can have any suitable reduction in the amount of the manganese, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the filter or absorption assembly 34 or the water that emerges from a distillation or rectification assembly (e.g., at least one of water having a substantially gaseous phase, condensed water having a substantially liquid phase, and cleaned water having a substantially liquid phase) can have any suitable concentration of magnesium (e.g., elemental magnesium or compounds including magnesium), such as about 10 wt % or less, or about 5 wt %, 4.5, 4, 3.5, 3, 2.5, 2, 1.5, 1, 0.5, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the evaporator and enters the recycle assembly, the water that emerges from the filter or absorption assembly 34 or the water that emerges from a distillation or rectification assembly can have any suitable reduction in the amount of the magnesium, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the filter or absorption assembly 34 or the water that emerges from a distillation or rectification assembly (e.g., at least one of water having a substantially gaseous phase, condensed water having a substantially liquid phase, and cleaned water having a substantially liquid phase) can have any suitable concentration of silica, such as about 10 wt % or less, or about 5 wt %, 4.5, 4, 3.5, 3, 2.5, 2, 1.5, 1, 0.5, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the evaporator and enters the recycle assembly, the water that emerges from the filter or absorption assembly 34 or the water that emerges from a distillation or rectification assembly can have any suitable reduction in the amount of the cobalt, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the filter or absorption assembly 34 or the water that emerges from a distillation or rectification assembly (e.g., at least one of water having a substantially gaseous phase, condensed water having a substantially liquid phase, and cleaned water having a substantially liquid phase) can have any suitable concentration of cyclopentanone, such as about 10 wt % or less, or about 5 wt %, 4.5, 4, 3.5, 3, 2.5, 2, 1.5, 1, 0.5, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the evaporator and enters the recycle assembly, the water that emerges from the filter or absorption assembly 34 or the water that emerges from a distillation or rectification assembly can have any suitable reduction in the amount of the cyclopentanone, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the filter or absorption assembly 34 or the water that emerges from a distillation or rectification assembly (e.g., at least one of water having a substantially gaseous phase, condensed water having a substantially liquid phase, and cleaned water having a substantially liquid phase) can have any suitable concentration of hexamethyleneimine, such as about 10 wt % or less, or about 5 wt %, 4.5, 4, 3.5, 3, 2.5, 2, 1.5, 1, 0.5, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the evaporator and enters the recycle assembly, the water that emerges from the filter or absorption assembly 34 or the water that emerges from a distillation or rectification assembly can have any suitable reduction in the amount of the hexamethyleneimine, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the filter or absorption assembly 34 or the water that emerges from a distillation or rectification assembly (e.g., at least one of water having a substantially gaseous phase, condensed water having a substantially liquid phase, and cleaned water having a substantially liquid phase) can have any suitable concentration of bis(hexamethylene)triamine, such as about 10 wt % or less, or about 5 wt %, 4.5, 4, 3.5, 3, 2.5, 2, 1.5, 1, 0.5, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the evaporator and enters the recycle assembly, the water that emerges from the filter or absorption assembly 34 or the water that emerges from a distillation or rectification assembly can have any suitable reduction in the amount of the bis(hexamethylene)triamine, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the filter or absorption assembly 34 or the water that emerges from a distillation or rectification assembly (e.g., at least one of water having a substantially gaseous phase, condensed water having a substantially liquid phase, and cleaned water having a substantially liquid phase) can have any suitable concentration of hexamethylenediamine, such as about 10 wt % or less, or about 5 wt %, 4.5, 4, 3.5, 3, 2.5, 2, 1.5, 1, 0.5, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the evaporator and enters the recycle assembly, the water that emerges from the filter or absorption assembly 34 or the water that emerges from a distillation or rectification assembly can have any suitable reduction in the amount of the hexamethylenediamine, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the filter or absorption assembly 34 or the water that emerges from a distillation or rectification assembly (e.g., at least one of water having a substantially gaseous phase, condensed water having a substantially liquid phase, and cleaned water having a substantially liquid phase) can have any suitable concentration of adipic acid, such as about 10 wt % or less, or about 5 wt %, 4.5, 4, 3.5, 3, 2.5, 2, 1.5, 1, 0.5, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the evaporator and enters the recycle assembly, the water that emerges from the filter or absorption assembly 34 or the cleaned water having a substantially liquid phase that emerges from a distillation or rectification assembly can have any suitable reduction in the amount of the adipic acid, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

In some instances, the water that passes through the filter or absorption assembly 34 can undergo further purification (e.g., by use of at least one of a distillation column, a rectification column, and a fractional distillation apparatus), such as to be reused (e.g., by addition to the beginning of the process or to be used as a source of steam in the methods and systems described herein for the production of polyamides). In one embodiment, the cleaned water having a substantially liquid phase may be used as-is and may be transformed and used as a source of steam in the methods and systems described herein for the production of polyamides.

In one embodiment, the water having a substantially liquid phase may be routed by line 42, valve 46, and line 48 to reactor 50, which may be in fluid communication by line 44, valve 46, and line 48 with evaporator 18. Reactor 50 may be configured to receive the concentrated aqueous solution from evaporator 18. Evaporator 18 may be any suitable evaporator. Reactor 50 may be any suitable reactor, including a baffled reactor. Optionally line 42 can feed material to other locations other than reactor 50, such as to reservoir 10.

In an embodiment, a portion of the water having a substantially liquid phase may be routed by line 42, valve 46, and line 48 to reactor 50 (or to locations other than reactor 50, such as reservoir 10) and another portion of the water having a substantially liquid phase may be routed by line 28, valve 30, and line 32 to the filter or absorption assembly 34. In one embodiment, a portion of the water having a substantially liquid phase may be routed by line 42, valve 46, and line 48 to reactor 50; another portion of the water having a substantially liquid phase may be routed by line 28, valve 30, and line 32 to the filter or absorption assembly 34; and a portion of the water having a substantially liquid phase may be discarded in, e.g., a sewage system.

Regardless of how the water having a substantially liquid phase is ultimately reused (e.g., reused in the reservoir 10 or the reactor 50, optionally as steam), the methods and systems described herein can condense at least 80% or less of the water having a substantially gaseous phase that exits the condenser 26 by line 28 or line 42 into water having a substantially liquid phase. In some cases, at least 85%, at least 90%, at least 95%, at least 99%, from about 80% to about 100%, from about 80% to about 90%, from about 85% to about 95%, from about 90% to about 99% or about 100% of the water having a substantially gaseous phase that exits the condenser 26 by line 28 or line 42 can be condensed into water having a substantially liquid phase.

In one embodiment, a portion of the water having a substantially liquid phase can be transferred to a storage vessel (not shown) for, e.g., later use or discarded into the polyamide-producing facility's sewage system (not shown). In an embodiment, a portion of the water having a substantially liquid phase can be transferred to a storage vessel (not shown) for, e.g., later use; a portion can be discarded into the polyamide-producing facility's sewage system (not shown); and a portion can be reused by routing it to one or more components of a polyamide synthesis process (e.g., reused in one or more of the reservoir 10, evaporator 18, reactor 50, flasher 64 or finisher 72, optionally as steam).

In some examples, the methods and systems described herein further comprise operating at a water recycle ratio of at least 1:1, v/v. As used herein, the term “recycle ratio” refers broadly to the volume ratio of liquid water that is reused/recycled to the reservoir relative to the volume of “fresh” liquid water (i.e., water that comes from a source other than from condensing the water having a substantially gaseous phase into water having a substantially liquid phase) used to make, among other things, the aqueous solution contained in reservoir 10. In some examples, the water recycle ratio can be at least about 0.2:1 or less, or about 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2:1, 2.2:1, 2.4:1, 2.6:1, 2.8:1, 3:1, 3.5:1, 4:1, 4.5:1, 5:1, 6:1, 7:1, 8:1, 9:1; 20:1; 50:1, 100:1, or about 200:1 or more. In other examples, the water recycle ratios range from about 1:1 to about 200:1, e.g., from about 10:1 to about 100:1 or from about 25:1 to about 100:1. In some embodiments, the high recycle ratio results in reduced costs to operate the system, such as in jurisdictions that limit the amount of water that can be discharged into the sewer and require fees for exceeding the limits, such as resulting from decreased use of fresh water resulting in decreased water costs, or such as resulting from less consumption of demineralized water.

In evaporator 18, the aqueous solution comprising the dicarboxylic acid and the diamine can be concentrated by transforming a portion of the water having a substantially liquid phase (e.g., by heating at temperatures from about 100° C. to about 300° C.) to water having a substantially gaseous phase. In the evaporator 18, the dicarboxylic acid and the diamine can also be partially reacted to form an aqueous mixture comprising a polyamide prepolymer (e.g., a polyamide that is not substantially completely polymerized). The aqueous mixture comprising a polyamide prepolymer can be routed by line 44, valve 46, and line 48 to reactor 50 where unreacted dicarboxylic acid and the diamine and the polyamide prepolymer react further and form additional polyamide prepolymer.

As used herein, the term “polyamide prepolymer” refers broadly to unreacted dicarboxylic acid and diamine; to a polyamide that is not substantially completely polymerized (e.g., an oligomer); and to a mixture of unreacted dicarboxylic acid and diamine and polyamide that is not substantially completely polymerized (e.g., an oligomer). The polyamide prepolymer can be mostly or entirely comprised of the diamine/diacid salt or can be mostly or entirely comprised of polyamide, and need not include any substantial proportion, or any, of the diacid and diamine in their pure form.

The reaction mixture comprising the polyamide prepolymer, which may include unreacted dicarboxylic acid and the diamine, can be recirculated via a thermosyphon created by transforming a portion of the water having a substantially liquid phase to water having a substantially gaseous phase in the evaporator 18 or in reactor 50. Recirculation can occur via line 52, valve 54, line 56, line 44, valve 46, and line 48.

The reactor 50 can be equipped with rectification column 82 that may be in fluid communication with the reactor 50 by line 76, valve 80, and line 78. The rectification column 82 may, in turn, be in fluid communication with vent line 86, via line 84 and valve 88. The rectification column 82 may be any suitable rectification column. See, e.g., U.S. Pat. No. 3,900,450, which is incorporated by reference in its entirety herein. The rectification column may serve the purpose of removing any unreacted diamine that may be present in water having a substantially gaseous phase that may be routed into the rectification column 82 by line 76, valve 80, and line 78.

In some instances, vent line 86 may receive water having a substantially gaseous phase. The vent line may be in fluid communication with a scrubber system (not shown) or a suitable condenser (not shown), which can convert water having a substantially gaseous phase into water having a substantially liquid phase. A portion of the water having a substantially liquid phase can be transferred to a storage vessel (not shown) for, e.g., later use or discarded into the polyamide-producing facility's sewage system (not shown). In an embodiment, a portion of the water having a substantially liquid phase can be transferred to a storage vessel (not shown) for, e.g., later use; a portion can be discarded into the polyamide-producing facility's sewage system (not shown); and a portion can be reused (e.g., reused in the reservoir 10 or the reactor 50, optionally as steam).

Polyamide prepolymer that is formed in reactor 50 may be transferred by line 58, valve 60, and line 62 to flasher 64. The flasher 64, in turn, may be in fluid communication with finisher 72 by line 66, valve 70, and line 68. The finisher 72 may, in turn, be in fluid communication with line 73, valve 75, and line 74, through which the substantially polymerized polyamide may be transferred for further processing (e.g., spinning or pelletization). The yellowness index of the finished polyamide, such as pellets, can be any suitable yellowness index, and can be measured by any suitable method, such as ASTM D1925 or ASTM E313, such about 0.001 to about 50, about 0.01 to about 20, about 0.1 to about 15, or about 0.001 or less, 0.01, 0.1, 0.5, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 20, 25, 30, 40, or about 50 or more. In some embodiments, the yellowness index of the finished polyamide can be improved (e.g., less yellowness) due to removal of polyamide-degrading materials in the recycle apparatus.

In some examples, the one or more of the lines and valves mentioned herein, including those used to route the water having a substantially gaseous phase (e.g., line 20, valve 22, line 24, line 84, valve 88, and vent line 86) and the water having a substantially liquid phase (e.g., line 28, valve 30, line 32, line 42, valve 46, and line 48), are made of stainless steel or any other material that helps maintain, reduce or minimize the level of gelation-causing materials or polyamide-degrading materials, including iron and cobalt, in at least the cleaned water having a substantially liquid phase, since certain concentrations of gelation-causing materials can catalyze crosslinking during the formation of polyamides. Crosslinking of polyamides may be undesirable because it may lead to significant gel formation in the polyamide synthesis process. Gel formation, in turn, leads to the production of a polyamide product that may be susceptible to, among other things, thread breakage when the polyamide is further processed into threads.

As used herein, the term “iron” refers broadly to iron ions (e.g., in solution as Fe³⁺ and Fe²⁺ ions), elemental iron, iron oxides (e.g., FeO, Fe₂O₃, and Fe₃O₄), and other compounds of iron that can act as gelation-causing materials or polyamide-degrading materials.

As used herein, the term “cobalt” refers broadly to cobalt ions (e.g., in solution as Co³⁺ and Co²⁺ ions), elemental cobalt, and other compounds of cobalt that may act as gelation-causing materials or polyamide-degrading materials.

As used herein, the term “manganese” refers broadly to manganese ions, elemental manganese, and compounds of manganese.

As used herein, the term “magnesium” refers broadly to magnesium ions, elemental magnesium, and compounds of magnesium.

As used herein, the term “titanium” refers broadly to titanium ions, elemental titanium, and compounds of titanium.

### EXAMPLES

Continuous Polymerization Process.

The following process is performed in the Examples. In a continuous nylon 6,6 manufacturing process, adipic acid and hexamethylenediamine are combined in a salt strike in an approximately equimolar ratio in water to form an aqueous mixture containing nylon 6,6 salt and having about 50 wt % water. The aqueous salt is transferred to an evaporator at approximately 105 L/min. The evaporator heats the aqueous salt to about 125-135° C. (130° C.) and removes water from the heated aqueous salt, bringing the water concentration to about 30 wt %. The evaporated salt mixture is transferred to a tubular reactor at approximately 75 L/min. The reactor raises the temperature of the evaporated salt mixture to about 218-250° C. (235° C.), allowing the reactor to further remove water from the heated evaporated salt mixture, bringing the water concentration to about 10 wt %, and causing the salt to further polymerize. The reacted mixture is transferred to a flasher at approximately 60 L/min. The flasher heats the reacted mixture to about 270-290° C. (285° C.) to further remove water from the reacted mixture, bringing the water concentration to about 0.5 wt %, and causing the reacted mixture to further polymerize. The flashed mixture, having a relative viscosity of about 13, is transferred to a finisher at approximately 54 L/min. In the transfer piping between the flasher and the finisher, the polymer mixture maintains a temperature of about 285° C. The finisher subjects the polymeric mixture to a vacuum to further remove water, bringing the water concentration to about 0.1 wt % and the relative viscosity to about 60, such that the polyamide achieves a suitable final range of degree of polymerization before transferring the finished polymeric mixture to an extruder and a pelletizer at about 54 L/min.

General Method for Determination of Gelation Rate.

Each gelation rate described in the Examples is determined by taking an average of the gelation rate as determined by two methods. In the first method, while the reaction mixture is still hot the system is drained of the liquid reaction mixture, the system is cooled, diassembled, and visually inspected to estimate the volume of gel therein. In the second method, while the reaction mixture is still hot the system is drained of liquid reaction mixture, cooled, filled with water, and drained of the water. The volume of water drained from the system is subtracted from the gel-free volume of the system to determine the volume of gel in the system. For determination of gelation rates in one or more specific pieces of equipment or downstream of a particular location, only the specific pieces of equipment or the system downstream of the particular location is filled with water. In both methods, the density of the gel is estimated at 0.9 g/cm³.

The variable X is a constant value throughout the Examples. Rectification columns have side or bottom draws for at least partial separation of solid impurities and materials having lower boiling points than water.

### Example 1

### Comparative. No Removal of Impurities from Recycle Water

The continuous polymerization process is performed. The vaporous water evaporated from the aqueous salt in the evaporator is condensed and recycled back to the salt strike. No purification of the condensed water occurs. Approximately 32 L/min of condensed unpurified water from the evaporator is recycled back to the salt strike. The evaporator recycle apparatus and associated transfer piping is primarily stainless steel. After 3-months online, the condensed unpurified water recycled to the salt strike contains about 100 ppm iron, about 50 ppm cobalt, about 1,000 ppm cyclopentanone, about 800 ppm hexamethyleneimine, about 500 ppm bis(hexamethylene)triamine, about 10,000 ppm hexamethylenediamine, and about 100 ppm adipic acid. The total amount of recycled water entering the salt strike is 32 L/min, which is combined with 24 L/min of demineralized fresh water, with a recycle ratio of 1.3:1. Finished polyamide pellets generated by the system have a yellowness index measured in accordance with ASTM D1925 of about 4.

Approximately 1 Kg/day of gel is generated in the continuous polymerization system. The evaporator recycle apparatus costs about X/day to operate. As compared to a corresponding process having no evaporator recycle apparatus, avoiding excess sewer discharge fines and using less demineralized fresh water saves about 30*X per day.

### Example 2

### Comparative No Removal of Impurities from Recycle Water, Carbon Steel Evaporator Recycle Apparatus

The continuous polymerization process is performed. The vaporous water evaporated from the aqueous salt in the evaporator is condensed and recycled back to the salt strike. No purification of the condensed water occurs. Approximately 32 L/min of condensed unpurified water from the evaporator is recycled back to the salt strike. The evaporator recycle apparatus and associated transfer piping is primarily carbon steel. After 3-months online, the condensed unpurified water recycled to the salt strike contains about 10,000 ppm iron, about 5,000 ppm cobalt, about 2,000 ppm cyclopentanone, about 1,600 ppm hexamethyleneimine, about 1,000 ppm bis(hexamethylene)triamine, about 10,000 ppm hexamethylenediamine, and about 100 ppm adipic acid. The total amount of recycled water entering the salt strike is 32 L/min, which is combined with 24 L/min of demineralized fresh water, with a recycle ratio of 1.3:1. Finished polyamide pellets generated by the system have a yellowness index measured in accordance with ASTM D1925 of about 5.

Approximately 2 Kg/day of gel is generated in the continuous polymerization system. The evaporator recycle apparatus costs about X/day to operate. As compared to a corresponding process having no evaporator recycle apparatus, avoiding excess sewer discharge fines and using less demineralized fresh water saves about 30*X per day.

### Example 3

### Comparative. No Removal of Impurities from Recycle Water, Corrosion Control-Treated Carbon Steel Evaporator Recycle Apparatus

The continuous polymerization process is performed. The vaporous water evaporated from the aqueous salt in the evaporator is condensed and recycled back to the salt strike. No purification of the condensed water occurs. Approximately 32 L/min of condensed unpurified water from the evaporator is recycled back to the salt strike. The evaporator recycle apparatus and associated transfer piping is primarily carbon steel that has been treated with a combination of sodium dihydrogen orthophosphate, sodium benzoate, sodium nitrite, and sodium nitrate. After 3-months online, the condensed unpurified water recycled to the salt strike contains about 100 ppm iron, about 50 ppm cobalt, about 1,000 ppm cyclopentanone, about 800 ppm hexamethyleneimine, about 500 ppm bis(hexamethylene)triamine, about 10,000 ppm hexamethylenediamine, and about 100 ppm adipic acid. Finished polyamide pellets generated by the system have a yellowness index measured in accordance with ASTM D1925 of about 4. The total amount of recycled water entering the salt strike is 32 L/min, which is combined with 24 L/min of demineralized fresh water, with a recycle ratio of 1.3:1.

Approximately 1 Kg/day of gel is generated in the continuous polymerization system. The evaporator recycle apparatus costs about X/day to operate. As compared to a corresponding process having no evaporator recycle apparatus, avoiding excess sewer discharge fines and using less demineralized fresh water saves about 30*X per day.

However, over a period of about three months, the corrosion-control materials leach out of the carbon steel, partially losing their corrosion-controlling effect and contaminating the polyamide product. After 3-months online, the purified water recycled to the salt strike contains about 100 ppm iron, about 50 ppm cobalt, about 1,000 ppm cyclopentanone, about 800 ppm hexamethyleneimine, about 500 ppm bis(hexamethylene)diamine, about 10,000 ppm hexamethylenediamine, and about 100 ppm adipic acid. After 6 month, the gel formation rate in the system is about 1.5 Kg/day, and finished polyamide pellets generated by the system have a yellowness index measured in accordance with ASTM D1925 of about 4.

### Example 4

### Comparative. Selective Removal of Some Impurities from Recycle Water

The continuous polymerization process is performed. The vaporous water evaporated from the aqueous salt in the evaporator is condensed and recycled back to the salt strike. The evaporator recycle apparatus and associated transfer piping is primarily stainless steel. Before returning the condensed water to the salt strike, the water is sent to a filter assembly containing a coarse filter (200 μm) in line with a fine filter (50 μm). Approximately 32 L/min of condensed water from the evaporator is recycled back to the salt strike. After 3-months online, the purified water recycled to the salt strike contains about 80 ppm iron, about 40 ppm cobalt, about 950 ppm cyclopentanone, about 750 ppm hexamethyleneimine, about 450 ppm bis(hexamethylene)diamine, about 10,000 ppm hexamethylenediamine, and about 100 ppm adipic acid. Finished polyamide pellets generated by the system have a yellowness index measured in accordance with ASTM D1925 of about 3.5. The total amount of recycled water entering the salt strike is 32 L/min, which is combined with 24 L/min of demineralized fresh water, with a recycle ratio of 1.3:1.

Approximately 0.9 Kg/day of gel is generated in the continuous polymerization system. The evaporator recycle apparatus costs about 2*X/day to operate. As compared to a corresponding process having no evaporator recycle apparatus, avoiding excess sewer discharge fines and using less demineralized fresh water saves about 30*X per day.

### Example 5

### Comparative. Selective Removal of Gelation-Causing Materials from Recycle Water

The continuous polymerization process is performed. The vaporous water evaporated from the aqueous salt in the evaporator is condensed and recycled back to the salt strike. The evaporator recycle apparatus and associated transfer piping is primarily stainless steel. The condensed water is purified by passing through a absorption assembly including an activated carbon sorbent bed containing about 10 Kg of activated carbon sorbent. Approximately 32 L/min of condensed water from the evaporator is recycled back to the salt strike. After 3-months online, the purified water recycled to the salt strike contains about 80 ppm iron, about 40 ppm cobalt, about 950 ppm cyclopentanone, about 750 ppm hexamethyleneimine, about 450 ppm bis(hexamethylene)diamine, about 9,000 ppm hexamethylenediamine, and about 90 ppm adipic acid. Finished polyamide pellets generated by the system have a yellowness index measured in accordance with ASTM D1925 of about 3.5. The total amount of recycled water entering the salt strike is 32 L/min, which is combined with 24 L/min of demineralized fresh water, with a recycle ratio of 1.3:1.

Approximately 0.9 Kg/day of gel is generated in the continuous polymerization system. The evaporator recycle apparatus costs about 2*X/day to operate. As compared to a corresponding process having no evaporator recycle apparatus, avoiding excess sewer discharge fines and using less demineralized fresh water saves about 30*X per day.

### Example 6

### Selective Removal of Gelation-Causing Materials from Recycle Water with 1:1 Recycle Ratio

The continuous polymerization process is performed. The vaporous water evaporated from the aqueous salt in the evaporator is condensed and recycled back to the salt strike. The evaporator recycle apparatus and associated transfer piping is primarily stainless steel. The condensed water is purified by passing through a filter assembly containing a coarse filter (200 μm) in line with a first fine filter (50 μm). The first fine filter is in line with an activated carbon sorbent bed containing about 50 Kg of activated carbon sorbent. The water then passes through a second fine filter (5 μm), before the water is recycled to the salt strike. Approximately 28 L/min of condensed water from the evaporator is recycled back to the salt strike (about 88 wt % of the total water removed in the evaporator). After 3-months online, the condensed unpurified water recycled to the salt strike contains about 10 ppm iron, about 5 ppm cobalt, about 100 ppm cyclopentanone, about 80 ppm hexamethyleneimine, about 50 ppm bis(hexamethylene)diamine, about 5,000 ppm hexamethylenediamine, and about 50 ppm adipic acid. Finished polyamide pellets generated by the system have a yellowness index measured in accordance with ASTM D1925 of about 1.5. The total amount of recycled water entering the salt strike is 28 L/min, which is combined with 28 L/min of demineralized fresh water, with a recycle ratio of 1:1.

Approximately 0.4 Kg/day of gel is generated in the continuous polymerization system. The system discharges about 4 L/min of water into the sewer system, resulting in fines for excessive discharge of water into the sewer. The system uses more demineralized fresh water than the other Examples. The sewer discharge fines and the increased demineralized fresh water consumption increase the operating costs of the system. The evaporator recycle apparatus costs about 3*X/day to operate. As compared to a corresponding process having no evaporator recycle apparatus, avoiding excess sewer discharge fines and using less demineralized fresh water saves about 3*X per day.

### Example 7

### Removal of Substantially all Impurities from Evaporator Apparatus Recycle Water

The continuous polymerization process is performed. The vaporous water evaporated from the aqueous salt in the evaporator is condensed and recycled back to the salt strike. The evaporator recycle apparatus and associated transfer piping is primarily stainless steel. The condensation is performed by passing through a 10 M tall 0.5 M diameter rectification column. The condensed water is passed through a filter assembly containing a coarse filter (200 μm) in line with a first fine filter (50 μm). The first fine filter is in line with at an activated carbon sorbent bed containing about 100 Kg of activated carbon sorbent. The water then passes through a second fine filter (5 μm) and a third fine filter (1 μm), before the water is recycled to the salt strike. Approximately 32 L/min of condensed water from the evaporator is recycled back to the salt strike. After 3-months online, the condensed purified water recycled to the salt strike contains about 1 ppm iron, about 0.5 ppm cobalt, about 10 ppm cyclopentanone, about 8 ppm hexamethyleneimine, about 5 ppm bis(hexamethylene)diamine, about 100 ppm hexamethylenediamine, and about 1 ppm adipic acid. Finished polyamide pellets generated by the system have a yellowness index measured in accordance with ASTM D1925 of about 1.4. The total amount of recycled water entering the salt strike is 32 L/min, which is combined with 24 L/min of demineralized fresh water, with a recycle ratio of 1.3:1.

Approximately 0.35 Kg/day of gel is generated in the continuous polymerization system. Pushing the mixture through the third fine filter adds about 2*X/day in costs to run the pump. Operating the rectification column requires about 10*X/day. The evaporator recycle apparatus costs about 15*X/day to operate. As compared to a corresponding process having no evaporator recycle apparatus, avoiding excess sewer discharge fines and using less demineralized fresh water saves about 30*X per day.

### Example 8

### Selective Removal of Gelation-Causing Materials from Recycle Water

The continuous polymerization process is performed. The vaporous water evaporated from the aqueous salt in the evaporator is condensed and recycled back to the salt strike. The evaporator recycle apparatus and associated transfer piping is primarily stainless steel. The condensation is performed by passing through a 3 M tall 0.5 M diameter rectification column. Approximately 32 L/min of condensed water from the evaporator is recycled back to the salt strike. After 3-months online, the condensed unpurified water recycled to the salt strike contains about 10 ppm iron, about 5 ppm cobalt, about 100 ppm cyclopentanone, about 80 ppm hexamethyleneimine, about 50 ppm bis(hexamethylene)diamine, about 5,000 ppm hexamethylenediamine, and about 50 ppm adipic acid. Finished polyamide pellets generated by the system have a yellowness index measured in accordance with ASTM D1925 of about 1.5. The total amount of recycled water entering the salt strike is 32 L/min, which is combined with 24 L/min of demineralized fresh water, with a recycle ratio of 1.3:1.

Approximately 0.4 Kg/day of gel is generated in the continuous polymerization system. The evaporator recycle apparatus costs about 3*X/day to operate. As compared to a corresponding process having no evaporator recycle apparatus, avoiding excess sewer discharge fines and using less demineralized fresh water saves about 30*X per day.

### Example 9

### Selective Removal of Elation-Causing Materials from Recycle Water

The continuous polymerization process is performed. The vaporous water evaporated from the aqueous salt in the evaporator is condensed and recycled back to the salt strike. The evaporator recycle apparatus and associated transfer piping is primarily stainless steel. The condensed water is purified by passing through a 3 M tall 0.5 M diameter rectification column, then a filter assembly containing a coarse filter (200 μm) in line with a first fine filter (50 μm). The first fine filter is in line with an activated carbon sorbent bed containing about 100 Kg of activated carbon sorbent. The water then passes through a second fine filter (5 μm), before the water is recycled to the salt strike. Approximately 32 L/min of condensed water from the evaporator is recycled back to the salt strike. After 3-months online, the condensed unpurified water recycled to the salt strike contains about 5 ppm iron, about 2.5 ppm cobalt, about 50 ppm cyclopentanone, about 40 ppm hexamethyleneimine, about 25 ppm bis(hexamethylene)diamine, about 2,500 ppm hexamethylenediamine, and about 25 ppm adipic acid. Finished polyamide pellets generated by the system have a yellowness index measured in accordance with ASTM D1925 of about 1.4. The total amount of recycled water entering the salt strike is 32 L/min, which is combined with 24 L/min of demineralized fresh water, with a recycle ratio of 1.3:1.

Approximately 0.35 Kg/day of gel is generated in the continuous polymerization system. The rectification column costs about 3*X/day to operate. The evaporator recycle apparatus costs about 6*X/day to operate. As compared to a corresponding process having no evaporator recycle apparatus, avoiding excess sewer discharge fines and using less demineralized fresh water saves about 30*X per day.

### Example 10

### Selective Removal of Elation-Causing Materials from Recycle Water Recycle Ratio of 4:1

The continuous polymerization process is performed. The vaporous water evaporated from the aqueous salt in the evaporator is condensed and recycled back to the salt strike. The evaporator recycle apparatus and associated transfer piping is primarily stainless steel. The condensed water is purified by passing through a filter assembly containing a coarse filter (200 μm) in line with a first fine filter (50 μm). The first fine filter is in line with an activated carbon sorbent bed containing about 50 Kg of activated carbon sorbent. The water then passes through a second fine filter (5 μm), before the water is recycled to the salt strike. Approximately 32 L/min of condensed water from the evaporator is recycled back to the salt strike. After 3-months online, the condensed unpurified water recycled from the evaporator to the salt strike contains about 10 ppm iron, about 5 ppm cobalt, about 100 ppm cyclopentanone, about 80 ppm hexamethyleneimine, about 50 ppm bis(hexamethylene)diamine, about 5,000 ppm hexamethylenediamine, and about 50 ppm adipic acid. Finished polyamide pellets generated by the system have a yellowness index measured in accordance with ASTM D1925 of about 1.5. Approximately 12.8 L/min of purified water from the reactor (about 69 wt % of total water removed from the reaction mixture in the reactor), which contains no impurities, is recycled back to the salt strike as well. The total amount of recycled water entering the salt strike is 44.8 L/min, which is combined with 11.2 L/min of demineralized fresh water, with a recycle ratio of 4:1.

Approximately 0.5 Kg/day of gel is generated in the continuous polymerization system. The evaporator recycle apparatus costs about 3*X/day to operate. As compared to a corresponding process having no evaporator recycle apparatus, avoiding excess sewer discharge fines and using less demineralized fresh water saves about 50*X per day.

### Example 11

### Selective Removal of Elation-Causing Materials from Recycle Water Recycle Ratio of 14.4:1

The continuous polymerization process is performed. The vaporous water evaporated from the aqueous salt in the evaporator is condensed and recycled back to the salt strike. The evaporator recycle apparatus and associated transfer piping is primarily stainless steel. The condensed water is purified by passing through a filter assembly containing a coarse filter (200 μm) in line with a first fine filter (50 μm). The first fine filter is in line with an activated carbon sorbent bed containing about 50 Kg of activated carbon sorbent. The water then passes through a second fine filter (5 μm), before the water is recycled to the salt strike. Approximately 32 L/min of condensed water from the evaporator is recycled back to the salt strike. After 3-months online, the condensed unpurified water recycled from the evaporator to the salt strike contains about 10 ppm iron, about 5 ppm cobalt, about 100 ppm cyclopentanone, about 80 ppm hexamethyleneimine, about 50 ppm bis(hexamethylene)diamine, about 5,000 ppm hexamethylenediamine, and about 50 ppm adipic acid. Finished polyamide pellets generated by the system have a yellowness index measured in accordance with ASTM D1925 of about 1.5. Approximately 18.5 L/min of purified water from the reactor (about 100 wt % of the water removed from the reaction mixture in the reactor), which contains no impurities, is recycled back to the salt strike as well. The total amount of recycled water entering the salt strike is 50.5 L/min, which is combined with 0.6 L/min of demineralized fresh water, with a recycle ratio of 14.4:1.

Approximately 0.5 Kg/day of gel is generated in the continuous polymerization system. The evaporator recycle apparatus costs about 3*X/day to operate. As compared to a corresponding process having no evaporator recycle apparatus, avoiding excess sewer discharge fines and using less demineralized fresh water saves about 60*X per day.

### Example 12

### Selective Removal of Elation-Causing Materials from Recycle Water Carbon Steel Evaporator Recycle Apparatus

The continuous polymerization process is performed. The vaporous water evaporated from the aqueous salt in the evaporator is condensed and recycled back to the salt strike. The evaporator recycle apparatus and associated transfer piping is primarily carbon steel. The condensed water is purified by passing through a filter assembly containing a coarse filter (200 μm) in line with a first fine filter (50 μm). The first fine filter is in line with an activated carbon sorbent bed containing about 50 Kg of activated carbon sorbent. The water then passes through a second fine filter (5 μm), before the water is recycled to the salt strike. Approximately 32 L/min of condensed water from the evaporator is recycled back to the salt strike. After 3-months online, the condensed unpurified water recycled to the salt strike contains about 75 ppm iron, about 40 ppm cobalt, about 200 ppm cyclopentanone, about 160 ppm hexamethyleneimine, about 100 ppm bis(hexamethylene)diamine, about 5,000 ppm hexamethylenediamine, and about 50 ppm adipic acid. Finished polyamide pellets generated by the system have a yellowness index measured in accordance with ASTM D1925 of about 2. The total amount of recycled water entering the salt strike is 32 L/min, which is combined with 24 L/min of demineralized fresh water, with a recycle ratio of 1.3:1.

Approximately 0.5 Kg/day of gel is generated in the continuous polymerization system. The evaporator recycle apparatus costs about 3*X/day to operate. As compared to a corresponding process having no evaporator recycle apparatus, avoiding excess sewer discharge fines and using less demineralized fresh water saves about 30*X per day.

### Example 13

### Selective Removal of Elation-Causing Materials from Recycle Water Carbon Steel Evaporator Recycle Apparatus

The continuous polymerization process is performed. The vaporous water evaporated from the aqueous salt in the evaporator is condensed and recycled back to the salt strike. The evaporator recycle apparatus and associated transfer piping is primarily carbon steel that has been treated with a combination of sodium dihydrogen orthophosphate, sodium benzoate, sodium nitrite, and sodium nitrate. The condensed water is purified by passing through a filter assembly containing a coarse filter (200 μm) in line with a first fine filter (50 μm). The first fine filter is in line with an activated carbon sorbent bed containing about 50 Kg of activated carbon sorbent. The water then passes through a second fine filter (5 μm), before the water is recycled to the salt strike. Approximately 32 L/min of condensed water from the evaporator is recycled back to the salt strike. After 3-months online, the condensed unpurified water recycled to the salt strike contains about 10 ppm iron, about 5 ppm cobalt, about 100 ppm cyclopentanone, about 80 ppm hexamethyleneimine, about 50 ppm bis(hexamethylene)diamine, about 5,000 ppm hexamethylenediamine, and about 50 ppm adipic acid. Finished polyamide pellets generated by the system have a yellowness index measured in accordance with ASTM D1925 of about 1.5. The total amount of recycled water entering the salt strike is 32 L/min, which is combined with 24 L/min of demineralized fresh water, with a recycle ratio of 1.3:1.

Approximately 0.4 Kg/day of gel is generated in the continuous polymerization system. The evaporator recycle apparatus costs about 3*X/day to operate. However, over a period of about 1 month, the corrosion-control materials leach out of the carbon steel, partially losing their corrosion-controlling effect and contaminating the polyamide product. After 6-months online, the condensed unpurified water recycled to the salt strike contains about 75 ppm iron, about 40 ppm cobalt, about 200 ppm cyclopentanone, about 160 ppm hexamethyleneimine, about 100 ppm bis(hexamethylene)diamine, about 5,000 ppm hexamethylenediamine, and about 50 ppm adipic acid. Finished polyamide pellets generated by the system have a yellowness index measured in accordance with ASTM D1925 of about 2. After 6 months, the gel formation rate is about 0.5 Kg/day. As compared to a corresponding process having no evaporator recycle apparatus, avoiding excess sewer discharge fines and using less demineralized fresh water saves about 30*X per day.

Embodiments of the invention described and claimed herein are not to be limited in scope by the specific embodiments herein disclosed, since these embodiments are intended as illustration of several aspects of the disclosure. Any equivalent embodiments are intended to be within the scope of this disclosure. Indeed, various modifications of the embodiments in addition to those shown and described herein will become apparent to those skilled in the art from the foregoing description. Such modifications are also intended to fall within the scope of the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein. In addition, where features or aspects of the invention are described in terms of Markush groups, those skilled in the art will recognize that the invention is also thereby described in terms of any individual member or subgroup of members of the Markush group.

As used herein and in the appended claims, the singular forms “a,” “an,” and “the” include plural reference unless the context clearly dictates otherwise. Thus, for example, a reference to “a reactor” includes a plurality of reactors, such as in a series of reactors. In this document, the term “or” is used to refer to a nonexclusive or, such that “A or B” includes “A but not B,” “B but not A,” and “A and B,” unless otherwise indicated.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In the methods described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

All publications, including non-patent literature (e.g., scientific journal articles), patent application publications, and patents mentioned in this specification are incorporated by reference as if each were specifically and individually indicated to be incorporated by reference.

The present invention provides for the following embodiments, the numbering of which is not to be construed as designating levels of importance:

Statement 1 provides a method for manufacturing a polyamide comprising: obtaining, from a reservoir, an aqueous solution comprising a dicarboxylic acid, a diamine, and water having a substantially liquid phase; concentrating the aqueous solution including transforming a portion of the water having a substantially liquid phase to water having a substantially gaseous phase; condensing the water having a substantially gaseous phase into condensed water having a substantially liquid phase; removing an impurity from at least one of the water having a substantially gaseous phase and the condensed water having a substantially liquid phase, to produce cleaned water having a substantially liquid phase, wherein the impurity comprises at least one of a gelation-causing material and a polyamide-degrading material; and reusing the cleaned water having a substantially liquid phase; wherein the method comprises operating at a water recycle ratio of at least 2:1.

Statement 2 provides the method of Statement 1, wherein reusing the cleaned water having a substantially liquid phase comprises returning the cleaned water having a substantially liquid phase to the reservoir or to a polyamide production reactor.

Statement 3 provides the method of any one of Statements 1-2, wherein the dicarboxylic acid is a C₄-C₁₈ α,ω-dicarboxylic acid.

Statement 4 provides the method of any one of Statements 1-3, wherein the dicarboxylic acid is a C₄-C₁₀ α,ω-dicarboxylic acid.

Statement 5 provides the method of any one of Statements 1-4, wherein the dicarboxylic acid is a C₄-C₈ α,ω-dicarboxylic acid.

Statement 6 provides the method of any one of Statements 1-5, wherein the dicarboxylic acid is adipic acid.

Statement 7 provides the method of any one of Statements 1-6, wherein the diamine is a C₄-C₁₈ α,ω-diamine.

Statement 8 provides the method of any one of Statements 1-7, wherein the diamine is a C₄-C₁₀ α,ω-diamine.

Statement 9 provides the method of any one of Statements 1-8, wherein the diamine is a C₄-C₈ α,ω-diamine.

Statement 10 provides the method of any one of Statements 1-9, wherein the diamine is hexamethylenediamine.

Statement 11 provides the method of any one of Statements 1-10, wherein the polyamide is nylon 6,6.

Statement 12 provides the method of any one of Statements 1-11 further comprising forming an ammonium salt of the diamine and the dicarboxylic acid in the reservoir.

Statement 13 provides the method of any one of Statements 1-12, wherein the concentrating comprises passing the aqueous solution through an evaporator.

Statement 14 provides the method of any one of Statements 1-13, wherein removing the impurity comprises removing at least one of iron, cobalt, manganese, magnesium, titanium, silica, cyclopentanone, hexamethyleneimine, and bis-hexamethyleneadiamine.

Statement 15 provides the method of any one of Statements 1-14, wherein reusing the cleaned water having a substantially liquid phase passing the cleaned water having a substantially liquid phase through one or more stainless steel conduits.

Statement 16 provides the method of any one of Statements 1-15, wherein condensing the water having a substantially gaseous phase into condensed water having a substantially liquid phase comprises condensing at least 80 wt % of the water having a substantially gaseous phase.

Statement 17 provides the method of any one of Statements 1-16, wherein removing the impurity comprises passing the condensed water having a substantially liquid phase through a filter or absorption system comprising at least one activated carbon sorbent bed.

Statement 18 provides the method of any one of Statements 1-17, wherein removing the impurity comprising passing the water having a substantially gaseous phase through at least one of a distillation column, a rectification column, and fractional distillation.

Statement 19 provides the method of any one of Statements 1-18, wherein the cleaned water having a substantially liquid phase is sufficiently pure to be used as a source of steam.

Statement 20 provides the method of any one of Statements 1-19, wherein condensing the water having a substantially gaseous phase into condensed water having a substantially liquid phase comprises contacting a condenser assembly with the water having a substantially gaseous phase, thereby condensing the water having a substantially gaseous phase into water having a substantially liquid phase.

Statement 21 provides the method of any one of Statements 1-20, wherein the impurity comprises at least one selected from the group consisting of iron, cobalt, manganese, magnesium, titanium, silica, cyclopentanone, hexamethyleneimine, and bis-hexamethyleneadiamine.

Statement 22 provides the method of Statement 21, wherein the impurity comprises iron.

Statement 23 provides a system comprising: a reservoir configured to mix or store an aqueous solution; an evaporator assembly, in fluid communication with the reservoir, configured to receive the aqueous solution and transform a portion of the aqueous solution into water having a substantially gaseous phase; a condensation assembly, in fluid communication with the evaporator assembly, configured to receive the water having a substantially gaseous phase and transform the water having a substantially gaseous phase into condensed water having a substantially liquid phase; a collection assembly configured to collect the condensed water having a substantially liquid phase from the condensation assembly; a filtration or absorption assembly configured to remove at least one impurity from at least one of the condensed water having a substantially liquid phase and the water having a substantially gaseous phase, to produce cleaned water having a substantially liquid phase; and a conduit network configured to return the cleaned water having a substantially liquid phase to at least one component of a polyamide production system; wherein the system operates at a water recycle ratio of at least 2:1.

Statement 24 provides an apparatus for manufacturing a polyamide comprising: a reservoir configured to mix or store an aqueous solution; an evaporator assembly, in fluid communication with the reservoir, configured to receive the aqueous solution and transform a portion of the aqueous solution into water having a substantially gaseous phase; a condensation assembly, in fluid communication with the evaporator assembly, configured to receive the water having a substantially gaseous phase and transform the water having a substantially gaseous phase into condensed water having a substantially liquid phase; a collection assembly configured to collect the condensed water having a substantially liquid phase from the condensation assembly; a filtration or absorption assembly configured to remove at least one impurity from at least one of the condensed water having a substantially liquid phase and the water having a substantially gaseous phase, to produce cleaned water having a substantially liquid phase; and a conduit network configured to return the cleaned water having a substantially liquid phase to at least one component of a polyamide manufacturing system; wherein the apparatus operates at a water recycle ratio of at least 1:1.

Statement 25 provides the apparatus of Statement 24, wherein the apparatus is configured to reuse the cleaned water having a substantially liquid phase by returning the cleaned water having a substantially liquid phase to the reservoir or to a polyamide production reactor.

Statement 26 provides the apparatus of any one of Statements 24-25, wherein the apparatus is configured to polymerize a dicarboxylic acid and a diamine.

Statement 27 provides the apparatus of Statement 26, wherein the dicarboxylic acid is a C4-C18 α,ω-dicarboxylic acid.

Statement 28 provides the apparatus of any one of Statements 26-27, wherein the dicarboxylic acid is a C4-C10 α,ω-dicarboxylic acid.

Statement 29 provides the apparatus of any one of Statements 26-28, wherein the dicarboxylic acid is a C4-C8 α,ω-dicarboxylic acid.

Statement 30 provides the apparatus of any one of Statements 26-29, wherein the dicarboxylic acid is adipic acid.

Statement 31 provides the apparatus of any one of Statements 26-30, wherein the diamine is a C4-C18 α,ω-diamine.

Statement 32 provides the apparatus of any one of Statements 26-31, wherein the diamine is a C4-C10 α,ω-diamine.

Statement 33 provides the apparatus of any one of Statements 26-32, wherein the diamine is a C4-C8 α,ω-diamine.

Statement 34 provides the apparatus of any one of Statements 26-33, wherein the diamine is hexamethylenediamine.

Statement 35 provides the apparatus of any one of Statements 24-34, wherein the polyamide is nylon 6,6.

Statement 36 provides the apparatus of any one of Statements 24-35, wherein the apparatus is configured to form an ammonium salt of the diamine and the dicarboxylic acid in the reservoir.

Statement 37 provides the apparatus of any one of Statements 24-36, wherein the condensation assembly is configured to transform at least 80% of the water having a substantially gaseous phase into water having a substantially liquid phase.

Statement 38 provides the apparatus of any one of Statements 24-37, wherein the filtration or absorption assembly comprises at least one activated carbon sorbent bed.

Statement 39 provides the apparatus of any one of Statements 24-38, wherein the filtration or absorption assembly is configured to remove the at least one impurity from the condensed water having a substantially liquid phase.

Statement 40 provides the apparatus of any one of Statements 24-39, wherein the condensation assembly comprises at least one of a distillation column, a rectification column, and a fractional distillation apparatus.

Statement 41 provides the apparatus of any one of Statements 24-40, wherein the condensation assembly is configured to remove at least one impurity from the water having a substantially gaseous phase.

Statement 42 provides the apparatus of Statement 41, wherein the impurity comprises at least one of cyclopentanone, hexamethyleneimine, and bis(hexamethylene)triamine.

Statement 43 provides the apparatus of any one of Statements 24-42, wherein the impurity comprises at least one of silica, iron, manganese, magnesium, titanium, and cobalt.

Statement 44 provides the apparatus of any one of Statements 24-43, wherein the impurity comprises iron.

Statement 45 provides the apparatus of any one of Statements 24-44, wherein the apparatus is configured to substantially purify the water having a substantially liquid phase so that it is sufficiently pure to be used as a source of steam.

Statement 46 provides a system comprising: a reservoir configured to mix or store an aqueous solution; an evaporator assembly, in fluid communication with the reservoir, configured to receive the aqueous solution and transform a portion of the aqueous solution into water having a substantially gaseous phase; a condensation assembly, in fluid communication with the evaporator assembly, configured to receive the water having a substantially gaseous phase and transform the water having a substantially gaseous phase into a cleaned condensed water having a substantially liquid phase, wherein the condensation assembly comprises at least one of a distillation column, a rectification column, and a fractional distillation apparatus, wherein the condensation assembly is configured to remove at least one impurity from the water having a substantially gaseous phase; a collection assembly configured to collect the cleaned condensed water having a substantially liquid phase from the condensation assembly; and a conduit network configured to return the cleaned water having a substantially liquid phase to at least one component of a polyamide production system; wherein the system operates at a water recycle ratio of at least 1:1.

Statement 47 provides an apparatus for manufacturing a polyamide comprising: a reservoir configured to mix or store an aqueous solution; an evaporator assembly, in fluid communication with the reservoir, configured to receive the aqueous solution and transform a portion of the aqueous solution into water having a substantially gaseous phase; a condensation assembly, in fluid communication with the evaporator assembly, configured to receive the water having a substantially gaseous phase and transform the water having a substantially gaseous phase into a cleaned condensed water having a substantially liquid phase, wherein the condensation assembly comprises at least one of a distillation column, a rectification column, and a fractional distillation apparatus, wherein the condensation assembly is configured to remove at least one impurity from the water having a substantially gaseous phase; a collection assembly configured to collect the cleaned condensed water having a substantially liquid phase from the condensation assembly; and a conduit network configured to return the cleaned water having a substantially liquid phase to at least one component of a polyamide manufacturing system; wherein the apparatus operates at a water recycle ratio of at least 1:1.

1. A method for manufacturing a polyamide comprising:
obtaining, from a reservoir, an aqueous solution comprising a dicarboxylic acid, a diamine, and water having a substantially liquid phase;
concentrating the aqueous solution including transforming a portion of the water having a substantially liquid phase to water having a substantially gaseous phase;
condensing the water having a substantially gaseous phase into condensed water having a substantially liquid phase;
removing an impurity from at least one of the water having a substantially gaseous phase and the condensed water having a substantially liquid phase, to produce cleaned water having a substantially liquid phase, wherein the impurity comprises at least one of a gelation-causing material and a polyamide-degrading material; and
reusing the cleaned water having a substantially liquid phase;
wherein the method comprises operating at a water recycle ratio of at least 1:1.

2. The method of claim 1, wherein reusing the cleaned water having a substantially liquid phase comprises returning the cleaned water having a substantially liquid phase to the reservoir or to a polyamide production reactor.

3. The method of claim 1 further comprising forming an ammonium salt of the diamine and the dicarboxylic acid in the reservoir.

4. The method of claim 1, wherein the concentrating comprises passing the aqueous solution through an evaporator.

5. The method of claim 1, wherein removing the impurity comprises removing at least one of cyclopentanone, hexamethyleneimine, and bis-hexamethyleneadiamine.

6. The method of claim 1, wherein reusing the cleaned water having a substantially liquid phase passing the cleaned water having a substantially liquid phase through one or more stainless steel conduits.

7. The method of claim 1, wherein condensing the water having a substantially gaseous phase into condensed water having a substantially liquid phase comprises condensing at least 80 wt % of the water having a substantially gaseous phase.

8. The method of claim 1, wherein removing the impurity comprises passing the condensed water having a substantially liquid phase through a filter or absorption system comprising at least one activated carbon sorbent bed.

9. The method of claim 1, wherein removing the impurity comprising passing the water having a substantially gaseous phase through at least one of a distillation column, a rectification column, and fractional distillation.

10. The method of claim 1, wherein condensing the water having a substantially gaseous phase into condensed water having a substantially liquid phase comprises contacting a condenser assembly with the water having a substantially gaseous phase, thereby condensing the water having a substantially gaseous phase into water having a substantially liquid phase.

11. The method of claim 1, wherein the impurity comprises at least one selected from the group consisting of iron, cobalt, titanium, magnesium, manganese, silica, cyclopentanone, hexamethyleneimine, and bis-hexamethyleneadiamine.

12. The method of claim 11, wherein the impurity comprises iron.

13. An apparatus for manufacturing a polyamide comprising:
a reservoir configured to mix or store an aqueous solution;
an evaporator assembly, in fluid communication with the reservoir, configured to receive the aqueous solution and transform a portion of the aqueous solution into water having a substantially gaseous phase;
a condensation assembly, in fluid communication with the evaporator assembly, configured to receive the water having a substantially gaseous phase and transform the water having a substantially gaseous phase into condensed water having a substantially liquid phase;
a collection assembly configured to collect the condensed water having a substantially liquid phase from the condensation assembly;
a filtration or absorption assembly configured to remove at least one impurity from at least one of the condensed water having a substantially liquid phase and the water having a substantially gaseous phase, to produce cleaned water having a substantially liquid phase; and
a conduit network configured to return the cleaned water having a substantially liquid phase to at least one component of a polyamide manufacturing system;
wherein the apparatus operates at a water recycle ratio of at least 1:1.

14. The apparatus of claim 13, wherein the apparatus is configured to reuse the cleaned water having a substantially liquid phase by returning the cleaned water having a substantially liquid phase to the reservoir or to a polyamide production reactor.

15. The apparatus of claim 13, wherein the condensation assembly is configured to transform at least 80% of the water having a substantially gaseous phase into water having a substantially liquid phase.

16. The apparatus of claim 13, wherein the filtration or absorption assembly comprises at least one activated carbon sorbent bed.

17. The apparatus of claim 13, wherein the filtration or absorption assembly is configured to remove the at least one impurity from the condensed water having a substantially liquid phase.

18. The apparatus of claim 13, wherein the condensation assembly comprises at least one of a distillation column, a rectification column, and a fractional distillation apparatus.

19. The apparatus of claim 13, wherein the condensation assembly is configured to remove at least one impurity from the water having a substantially gaseous phase.

20. An apparatus for manufacturing a polyamide comprising:
a reservoir configured to mix or store an aqueous solution;
an evaporator assembly, in fluid communication with the reservoir, configured to receive the aqueous solution and transform a portion of the aqueous solution into water having a substantially gaseous phase;
a condensation assembly, in fluid communication with the evaporator assembly, configured to receive the water having a substantially gaseous phase and transform the water having a substantially gaseous phase into a cleaned condensed water having a substantially liquid phase, wherein the condensation assembly comprises at least one of a distillation column, a rectification column, and a fractional distillation apparatus, wherein the condensation assembly is configured to remove at least one impurity from the water having a substantially gaseous phase;
a collection assembly configured to collect the cleaned condensed water having a substantially liquid phase from the condensation assembly; and
a conduit network configured to return the cleaned water having a substantially liquid phase to at least one component of a polyamide manufacturing system;
wherein the apparatus operates at a water recycle ratio of at least 1:1.
